(19) United States
(12) Patent Application Publication
(10) Pub. No.: US 2019/0217320 A1
(43) Pub. Date: Jul. 18, 2019

(54) TREATMENT INSTALLATION AND METHOD FOR TREATING WORKPIECES

(71) Applicant: EISENMANN SE, Boblingen (DE)

(72) Inventor: Herbert Schulze, Aidlingen (DE)

(21) Appl. No.: 16/247,001

(22) Filed: Jan. 14, 2019

(30) Foreign Application Priority Data
Jan. 15, 2018 (DE) 10 2018 100 719.1
Feb. 15, 2018 (DE) 10 2018 103 454.7

(51) Int. Cl. B05B 12/18; B05B 15/00

(52) U.S. Cl. CPC B05B 12/18; B05B 15/00

(57) ABSTRACT

A treatment installation for treating workpieces, in particular for coating and/or drying of vehicle bodies, having a treatment device with a housing, in which a treatment tunnel is accommodated. A conveyor system having a plurality of trolleys which can convey the workpieces through the treatment tunnel, wherein each of the trolleys has a chassis and a securing device for at least one workpiece which are coupled together by a coupling device. Outside the treatment tunnel a guidance zone with a driving area for the chassis is present. In the guidance zone a gas compartment is configured, arranged between the driving area and the treatment tunnel and delimited by a separate housing. A gas supply device is present which can supply the gas compartment with a gas, such that in the gas compartment a gas barrier is created between the treatment tunnel and the driving area.

### RELATED APPLICATIONS

The present application claims priority to German Application No. 10 2018 100 719.1 filed Jan. 15, 2018 and German Application No. 10 2018 103 454.7 filed Feb. 15, 2018—the contents of both of which are fully incorporated herein by reference.

### FIELD OF THE INVENTION

The invention relates to a treatment installation for treating workpieces, in particular for coating and/or drying of vehicle bodies, with
a) a treatment device with a housing, in which a treatment tunnel is accommodated;
b) a conveyor system, comprising a plurality of trolleys, by means of which the workpieces are transportable through the treatment tunnel, wherein each trolley comprises a chassis and a securing device for at least one workpiece, which are coupled together by means of a coupling device;
   wherein
c) outside the treatment tunnel a guidance zone with a driving area for the chassis is present.

The invention also relates to a method for treating workpieces, in particular for coating and/or drying vehicle bodies, comprising the passing of workpieces through a treatment tunnel by means of a conveyor system, comprising a plurality of trolleys, by means of which the workpieces are conveyed through the treatment tunnel, wherein each trolley comprises a chassis and a securing device for at least one workpiece, which are coupled together by means of a coupling device, and wherein outside the treatment tunnel and a guidance zone with a driving area for the chassis is present.

### BACKGROUND OF THE INVENTION

In such a treatment installation, treatment devices, in particular in the form of coating booths or dryers are present. In coating booths, the workpieces are provided with a coating and, by way of example, painted; in this case the treatment tunnel is a coating tunnel or a painting tunnel. In the case of a dryer, the treatment tunnel is accordingly a drying tunnel.

Treatment devices can also be present in the form of assembly facilities and/or inspection facilities, in which the workpieces are assembled, or assembly work is performed on the workpieces, or in which the workpieces are inspected in the continuous production process.

In such treatment devices, in a tunnel wall, which separates the treatment tunnel from the guidance zone, there is accordingly a connecting passage, through which at least the coupling device of a trolley extends. A tunnel wall is understood to be any delimitation of the treatment tunnel, and thus includes not only side walls but also a ceiling or floor.

Through such a connecting passage it is possible for the atmosphere of the treatment tunnel to enter the driving area. In particular during drying, this atmosphere is charged with solvents, which then condense in the generally cooler driving area and can deposit on the components of the conveyor technology in the driving area. This corrodes the conveyor system, however.

A treatment installation and a method of the abovementioned type are described in DE 10 2015 006 098 A1, which discloses a dryer for vehicle bodies. Screening means are proposed there which are able to at least reduce the tunnel atmosphere entering the driving area.

DE 20 2017 106 843 U1 proposes a treatment installation and a method of the abovementioned type in which a gas is intended to be supplied to the driving area, such that gas always flows out of the driving area into the treatment tunnel and not the other way around. However, the considerable disadvantage here is that impurities can be introduced from the driving area into the treatment tunnel. Such impurities can, in particular, involve abrasion or lubricants from the components of the conveyor system in the driving area. If the driving area does not have a separate housing, other impurities can also be drawn from the air in the installation's workshop into the treatment tunnel. However, the treatment of the workpieces in the treatment tunnel can be badly disrupted by such impurities. DE 20 2017 106 843 U1 proposes that the driving area has its own housing with pressurised gas being supplied to this. However, a comparatively large volume of gas has to be moved. In addition, at the ends of the driving area locks have to be provided in order to maintain the pressure in the driving area including during entry and exit by the trolleys; however, simply due to the necessary cross section, construction of these locks is complicated.

### SUMMARY OF THE INVENTION

Therefore, an object of the invention is to provide a treatment installation and a method of the abovementioned type, which addresses these issues.

This object may be achieved by a treatment installation of the abovementioned type, in that
d) in the guidance zone a gas compartment is configured, arranged between the driving area and the treatment tunnel and delimited by a separate housing;
e) a gas-supply device is present, by means of which the gas compartment can be supplied with a gas such that in the gas compartment a gas barrier is created between the treatment tunnel and the driving area.

Thus, according to the invention, between the driving area and the treatment tunnel a gas barrier is configured in a separate housing. This allows protection to be achieved in both directions, so that a transfer of atmosphere in any direction between the treatment tunnel and the driving area cannot take place. In addition, the volume of the gas compartment can remain considerably smaller than the driving area, resulting in a less complicated design of any necessary lock technology.

It is particularly advantageous if the gas compartment is connected via a first connecting passage with the treatment tunnel and via a second connecting passage with the driving area, such that the chassis of a trolley in the driving area is movable and in the process the securing device is also taken into the treatment tunnel and the coupling device extends through the first and the second connecting passage and the gas compartment. In this way, the gas present in the gas compartment always flows around the coupling device.

The first connecting passage and/or the second connecting passage are preferably straight or angled.

If, by means of the gas supply device a pressure can be developed in the gas compartment, which is greater than the pressure in the treatment tunnel and/or than the pressure in the driving area, it can be reliably ensured that tunnel atmosphere and/or driving area atmosphere are unable to enter the gas compartment. In any case, the pressure is preferably higher than the pressure in the treatment tunnel. If the pressure in the gas compartment is higher than both the pressure in the treatment tunnel and also the pressure in the driving area, an overflow of undesired atmospheres is reliably prevented.

The gas compartment is advantageously configured as a flow compartment, wherein the gas compartment housing to this end comprises one or more gas inlets gas inlets and one or more gas outlets.

Here, the gas supply device is preferably arranged such that the gas compartment is supplied through one or more gas inlets with gas for the gas barrier, which flows through the gas compartment along a flow path and in doing so in the gas compartment at least in part and at least in certain areas flows past the first connecting passage and/or second connecting passage and thereafter is discharged through one or more gas outlets from the gas compartment.

It is advantageous if, over the full longitudinal extension of the first connecting passage and/or the second connecting passage the gas barrier flows at least in part past these.

In order to increase the flow rate at the connecting passage(s), the gas compartment can advantageously comprise a flow guiding device, by means of which the flow section for the gas barrier is reduced, before gas of the gas barrier flows past the first connecting passage and/or the second connecting passage.

This can be achieved in an advantageous manner in that the flow guiding device comprises flow guiding elements.

It can be beneficial if the gas compartment is arranged such that the gas barrier is able to flow through it according to the counter current principle, so that gas of the gas barrier flows past the first connecting passage and past the second connecting passage in opposing flow directions.

It is advantageous, if the gas supply device comprises a conditioning device, by means of which the gas to be supplied to the gas compartment can be conditioned. The gas is preferably matched to the atmosphere in the treatment tunnel, in particular with regard to temperature and humidity.

From a materials handling point of view, it is advantageous if the guidance zone with the driving area and the gas compartment is configured below a tunnel floor of the treatment tunnel. This takes account of the desire for established bottom conveyor systems.

A coupling device with an uncomplicated design comprises at least one vertical strut, in particular an articulated strut. An articulated strut may be desirable if the trolleys of the conveyor system are intended to negotiate curves; this will be dealt with in more detail later on.

The abovementioned object may be achieved by a method of the abovementioned type in that a gas compartment, arranged in the guidance zone between the driving area and the treatment tunnel and delimited by a separate housing, is supplied with a gas such that in the gas compartment a gas barrier is created between the treatment tunnel and the driving area.

The advantages of this and the method steps described in the following correspond by analogy to the advantages described above of the corresponding features of the treatment installation.

It is correspondingly advantageous if the gas compartment is connected via a first connecting passage with the treatment tunnel and via a second connecting passage with the driving area, wherein the chassis of a trolley is moved in the driving area and in the process the securing device is also taken into the treatment tunnel and the coupling device extends through the first and the second connecting passage and the gas compartment.

Preferably, a pressure is developed in the gas compartment which is higher than the pressure in the treatment tunnel and/or the pressure in the driving area.

The gas compartment is preferably configured as a flow compartment, wherein the gas compartment housing to this end comprises one or more gas inlets gas inlets and one or more gas outlets.

The gas compartment is advantageously supplied through one or more gas inlets with gas for the gas barrier, which flows through the gas compartment along a flow path and in doing so in the gas compartment at least in part and at least in certain areas flows past the first connecting passage and/or to the second connecting passage and thereafter is discharged through one or more gas outlets from the gas compartment.

The gas barrier preferably flows over the full longitudinal extension of the first connecting passage and/or the second connecting passage at least in part past these.

It is advantageous, if the flow section for the gas barrier is reduced, before gas of the gas barrier flows past the first connecting passage and/or the second connecting passage, by means of a flow guiding device.

To this end, the flow guiding device advantageously comprises flow guiding elements.

It can be particularly beneficial if the gas compartment is arranged such that the gas barrier is able to flow through it according to the counter current principle, so that gas of the gas barrier flows past the first connecting passage and past the second connecting passage in opposing flow directions.

The gas to be supplied to the gas compartment is preferably conditioned by means of a conditioning device.

With regard to the floor conveyor system it is beneficial if the guidance zone with the driving area and the gas compartment is configured below a tunnel floor of the treatment tunnel.

Other advantages and aspects of the present invention will become apparent upon reading the following description of the drawings and detailed description of the invention.

### BRIEF DESCRIPTION OF THE DRAWINGS

Exemplary embodiments of the invention will now be explained in more detail on the basis of the drawings. These show as follows:

FIG. 1 a schematic view in vertical cross section of a treatment installation with a treatment chamber and a guidance zone arranged outside of the treatment chamber with a driving area for a transport system and a gas compartment for a gas barrier;

FIG. 2 a detailed view of a connecting passage between the treatment chamber and the guidance zone;

FIG. 3 a detailed view corresponding to FIG. 2 with a modified connecting passage;

FIG. 4 a vertical longitudinal section through the treatment installation, showing the gas compartment in the longitudinal direction;

FIG. 5 a schematic view of an exemplary embodiment with a modified gas compartment, in which a gas barrier can be created, which flows through the connecting passage between the treatment chamber and the guidance zone as a gas curtain, wherein a treatment installation with a coating device is shown;

FIG. 6 a detailed view of the gas compartment according to FIG. 5 in the region of the connecting passage between the coating chamber and the guidance zone in the coating device;

FIGS. 7 to 11 detailed views of an in each case modified gas compartment in the region of the connecting passage between the coating chamber and the guidance zone.

### DETAILED DESCRIPTION OF THE PRESENT INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

The figures schematically illustrate a treatment installation designated in its entirety as 10 for the treatment of workpieces 12 which, by way of example, are shown as vehicle bodies 14.

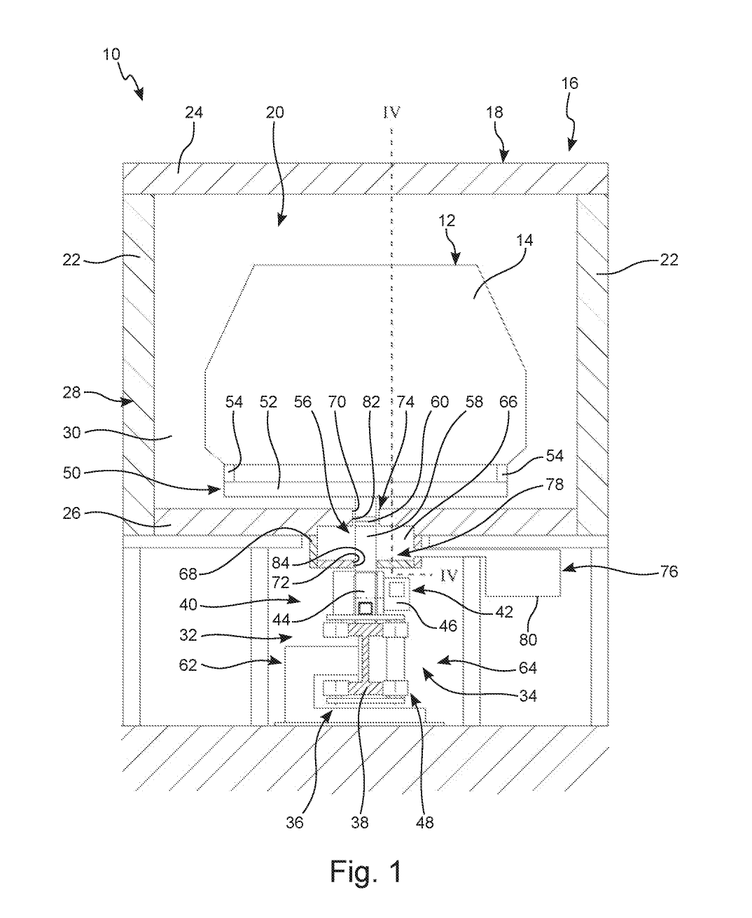

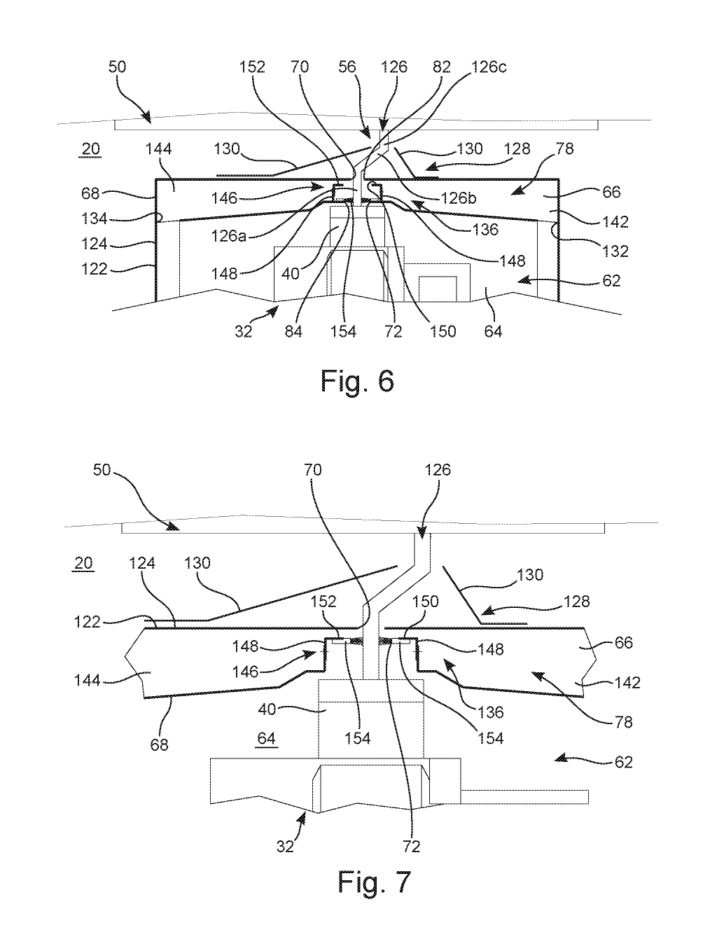

The treatment installation 10 comprises a treatment device 16 with a housing 18, delimiting a treatment chamber, configured as a treatment tunnel 20 and comprising two tunnel walls in the form of side walls 22 and two further tunnel walls in the form of a ceiling 24 and a tunnel floor 26. In a preferred exemplary embodiment, the treatment device 16 is a dryer 28, in which the treatment tunnel 20 defines a drying tunnel 30. Such a dryer is shown in FIGS. 1 to 4. FIGS. 5 to 11 show exemplary embodiments on the basis of a coating installation, in which the workpieces 14 are coated and in particular painted. This will be dealt with in more detail later on.

The workpieces 12 are conveyed by a conveyor system 32 through the treatment tunnel 20 of the treatment device 16. The treatment device 16 is in continuous operation and accordingly at one end has an inlet and at the opposite end an outlet. However, a treatment tunnel 20 or drying tunnel 30 are also understood to be treatment chambers, designed as a batch system and may only have a single access, via which the workpieces 12 enter the treatment chamber and following treatment are then conveyed out of it again.

The conveyor system 32 comprises a plurality of trolleys 34, on which the workpieces 12 are transported. The trolleys 34 are run on a rail system 36. In a modification, not specifically shown, the trolleys 34 can be configured as free-moving trolleys in the sense of driverless transport systems, which will be familiar to the person skilled in the art as what are known as FTS.

This rail system 36 has a single-track configuration and comprises a carrier rail 38, on which a trolley 34 runs and which in the present exemplary embodiment is configured as an in itself known I-profile. The rail system 36 can also be multi-track, in particular twin-track. The carrier rail 38 is floor-mounted and anchored to the floor of the system 10.

Each trolley 34 comprises a chassis 40 and a drive system 42, which in the present exemplary embodiment comprises a drive roller 44, running on the carrier rail 38 and by means of which a drive motor 46 can be driven. In this way, the trolleys 34 can be driven independently of one another. In the present exemplary embodiment, the drive roller 44 runs on the top of the carrier rail 38. In a modification, the drive roller 44 can also make lateral contact with the carrier rail 38.

In addition to, or instead of, the trolleys 34 described here, each with its own onboard drive system 42, other trolleys may also be present, driven by a central drive system. By way of example, such a central drive system can be configured as a chain drive or similar. The trolleys 34 described here can accordingly also be driven and run independently of other drive devices.

To prevent the trolley 34 tilting in the conveying direction or transversally to the conveying direction, a support system 48 is provided with support rollers that rest on the carrier rail 38 and prevent tilting of the trolley 34 in an in itself known manner.

The trolley 34 comprises a securing device 50, to which a workpiece 12 or a suitable workpiece carrier for workpieces 12 can be secured. For the securing of vehicle bodies 14 the securing device 50 in the present exemplary embodiment comprises a support profile 52 with bearing pins 54, which work in concert in an in itself known manner with counterparts on the vehicle body 14, so that the vehicle body 14 can be fastened to the securing device 50. The securing device 50 can also comprise a plurality of sets of such bearing pins 54, adapted to different vehicle bodies 14 with varying dimensions and designs, so that the securing device 50 can be used flexibly for different vehicle body types. The securing device 50 thus accepts a vehicle body 14 directly without the vehicle body 10 being secured to a workpiece carrier such as, by way of example, an in itself known skid.

The chassis 40 of the trolley 34 is coupled by means of a coupling device 56 with the securing device 50. In the present exemplary embodiment, the coupling device comprises at least one vertical strut 58, wherein for reasons of stability two vertical struts 58 are present; each strut 58 that is present couples the chassis 40 of the trolley 34 with the securing device 50.

The trolley 34 can be configured so that it is able to negotiate curved sections of the carrier rail 38. To this end the chassis 40 of the trolley 34 can in particular be designed with a leading unit and a trailing unit, joined together in an articulated fashion.

If the trolley 34 is designed to negotiate curves, the coupling between the chassis 40 and the securing device 50 by the coupling device 56 is arranged so that the corresponding negotiation of curves is possible. To this end, the struts 58 are, by way of example, configured as articulated struts 60, which through an articulation allow the securing device 50 to pivot about a vertical axis of rotation in relation to the chassis 40 of the trolley 34, as shown in the figures.

If the chassis 40 comprises a leading unit and a trailing unit, each of these two units can be connected in each case with a strut 58 or in each case with an articulated strut 60.

The treatment device 16 and the conveyor system 32 complement each other in such a way that only one part of the conveyor system 32 moves in the treatment chamber, i.e. in the treatment tunnel 20, while the other part of the conveyor system 32 is moved outside of the treatment tunnel 20.

To this end, outside the treatment tunnel 20 a guidance zone 62 with a driving area 64 is arranged, in which the rail system 30 is accommodated and in which the chassis 40 of a trolley 34 moves, wherein the treatment tunnel 20 and the guidance zone 62 are separated by a tunnel wall.

An arrangement of the guidance zone 62 “outside” the treatment tunnel 20 shall be understood to mean that a structural separation exists between the treatment tunnel 20 and the guidance zone 62 due to said tunnel wall. This does not mean that the guidance zone 62 cannot extend at least in sections into the treatment tunnel 20 and overlap in cross section with the treatment tunnel 20.

In the present exemplary embodiment, the tunnel wall, which separates the treatment tunnel 20 and the guidance zone 62 from one another, is the tunnel floor 26, wherein the guidance zone 62 with the driving area 64 is arranged below the tunnel floor 26.

The driving area 64 can be open to the environment of the treatment device 16; in any event, the driving area 64 does not have to have its own housing.

In a modification, not specifically shown, the driving area 64 is delimited by its own housing. Alternatively, the side walls 22 of the housing 18 can also extend downwards beyond the tunnel floor 26, such that they laterally delimit the driving area 64.

In the guidance zone 62 a gas compartment 66 is configured, delimited from a separate gas compartment housing 68. Separate means that the gas compartment housing 68 is present independently of other housings, by way of example of said own housing of the driving area 64 for the gas compartment 66. The gas compartment housing 68 does not have to have a gas-tight design, merely bringing about sufficient fluidic separation of the gas compartment 66 from the environment. In particular, the gas compartment housing 68 can be open at the ends, i.e. at the inlet and outlet of the treatment tunnel 20, if it is possible to dispense with locks.

The gas compartment 66 is arranged between the driving area 64 and the treatment tunnel 20 and is connected via a first connecting passage 70 in the gas compartment housing 68 with the treatment tunnel 20 and via a second connecting passage 72 with the driving area 64. The first and second through connection 70, 72 are complementary to the coupling device 56 of the trolley 34.

The coupling device 56 extends through both connecting passages 70, 72 and the gas compartment 66, so that the securing device 50 with the workpiece 12 is located in the treatment tunnel 20 and the chassis 40 of a trolley 34 in the driving area 64.

In the present exemplary embodiment, a section of the tunnel floor 26 forms an area of the gas compartment housing 68, wherein the first connecting passage 70 is configured in the tunnel floor 26.

Upon entry of a trolley 34 loaded with a vehicle body 14 into a treatment device 16, the coupling device 56 of the trolley 34 is thus, as it were, threaded through the connecting passages 70, 72 of the Gas compartment housing 68. If the vehicle bodies 14 are then conveyed through the treatment tunnel 26, the chassis 40 moves in the driving area 64 and also takes securing device 50 with it into the treatment tunnel 20, wherein the coupling device 56, i.e. in the present exemplary embodiment the struts 58 or the articulated struts 60, extends through the connecting passages 70 and 72 and through the gas compartment 66.

The treatment tunnel 20 and the driving area 64 are fluidically connected to one another via a flow path 74. This flow path 74 is at least always configured where the coupling device 56 of the trolley 34 extends between the treatment tunnel 20 and the driving area 64. In the exemplary embodiment described here a flow path 74 is accordingly in each case configured along the struts 58 or the articulated struts 60.

The gas compartment 66 can now be supplied, using a gas supply device 76, with a gas which, in practice, is air. But other gases, by way of example inert gases, such as nitrogen or similar, can also be considered.

With the help of the gas supply device 76, in the gas compartment 66 a gas barrier 78 between the treatment tunnel 20 of the treatment device 16 and the driving area 64 of the conveyor system 32 can be created and thus developed and maintained.

On the one hand the gas barrier 78 prevents tunnel atmosphere being able to flow from the treatment tunnel 20 into the driving area 64. This avoids the abovementioned formation of solvent condensate in the driving area 64 and corrosion of the conveyor system existing there.

To this end, the gas barrier 78 in the gas compartment 66 has a pressure, which is higher than the pressure in the treatment tunnel 20, so that gas flows from the gas compartment 66 through the first connecting passage 70 into the treatment tunnel 20. The gas compartment 66 is then designed as a pressure chamber.

The gas barrier 78 is in this case consequently a flowing gas barrier.

On the other hand, the gas barrier 78 can also prevent the atmosphere from the driving area 64 which, by way of example may be polluted with abrasion or lubricants from the conveyor system in the driving area 64, entering the treatment tunnel 20.

To this end, the gas barrier 78 in the gas compartment 66 has a pressure which is higher than the pressure in the driving area 64, so that the gas flows from the gas compartment 66 through the second connecting passage 72 into the driving area 64.

Since the gas in the gas compartment 66 is thus unpolluted by impurities from the driving area 64, fresh air can also be used as gas, which at the same time is considered in the fresh air supply to the treatment device 16. Thus, the fresh air needed from the outset can serve as the gas for the gas barrier as a result of which the necessary resources are used effectively.

The gas supply device 76 comprises a conditioning device 80, with which the gas supplied to the gas compartment 66 can be conditioned. Here in particular, the temperature of the gas can be matched to the temperature of the tunnel atmosphere in the region of the treatment tunnel 20, where the gas enters the treatment tunnel 20 from the gas compartment 66. Thus, excessively cold gas can, by way of example, be prevented from entering the treatment tunnel 20, which would lead to condensation of solvent in the treatment tunnel 20. However, with regard to the conveyor system in the driving area 64, the temperature of the gas is adapted so that a temperature harmful to the conveyor system is not reached. Furthermore, with the conditioning device 80 by way of example the humidity of the gas can be set.

For heating the gas, the conditioning device 80 can, by way of example, use the waste heat from the treatment installation 10 by, for example, transferring the heat from exhaust air occurring in the treatment installation 10 or from other process media to the gas by means of a heat exchanger.

In the exemplary embodiment shown in FIG. 1, the first and the second connecting passage 70 and 72 are configured, consistent with the vertically running struts 58 or the articulated struts 60, as vertical slits 82 or 84.

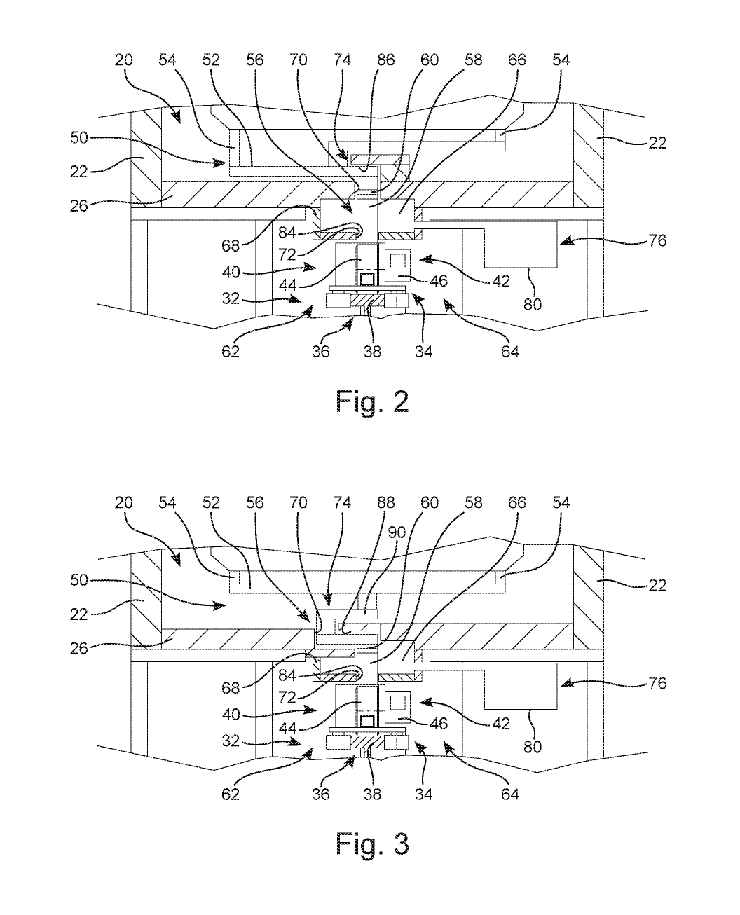

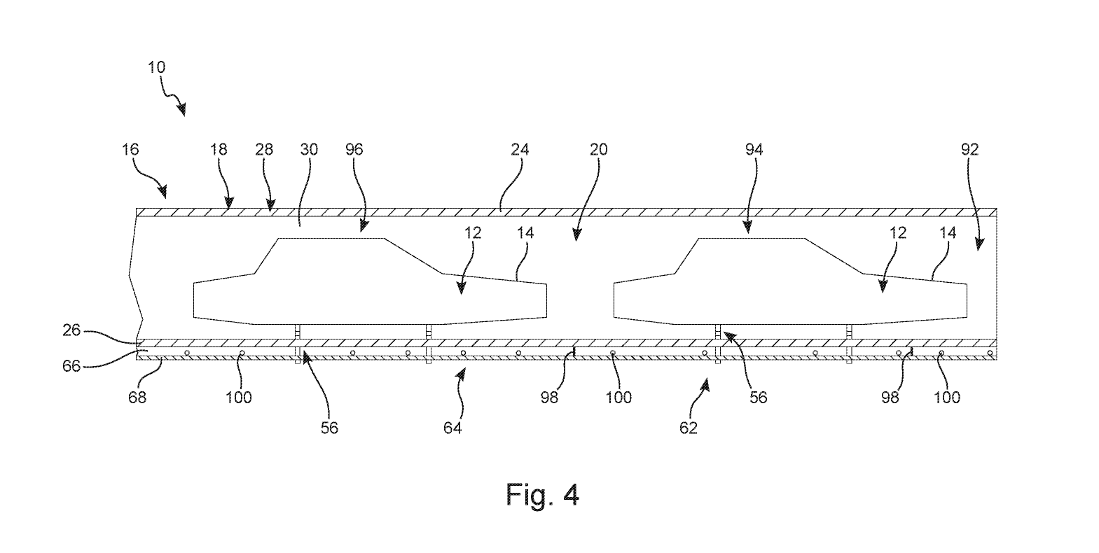

However, the first connecting passage 70 between the treatment tunnel 20 and the gas compartment 66 can, in particular, also be modified to be a labyrinth seal, by way of example as shown in FIGS. 2 and 3.

Such a labyrinth seal can have two effects. Firstly, it can at least make it harder for tunnel atmosphere to flow from the treatment tunnel 20 into the gas compartment 66. This offers an element of safety in the event of a malfunction of the gas supply device 76, which can lead to a collapse of the gas barrier 78. In this case a corresponding labyrinth seal provides an additional time window during which there continues to be no escape of tunnel atmosphere, which could then also flow from the gas compartment 66 into the driving area 64. To make this route difficult as well the second connecting passage 72 can be designed as a type of labyrinth seal, though this is not specifically shown.

On the other hand, a corresponding labyrinthine configuration of the first connecting passage 70 extends the dwell time of the gas in the region of the tunnel floor 26, which is heated due to the prevailing temperature in the treatment tunnel 20. This heat can thus be transferred to the gas more effectively than with the simply vertical slit 82, which can be used to match the temperature of the gas to the temperature of the tunnel atmosphere.

FIGS. 2 and 3 show two examples of a labyrinthine first connecting passage 70. In the exemplary embodiment shown in FIG. 2, the first connecting passage 70 between the treatment tunnel 20 and the gas compartment 66 is not straight and does not open in an upward direction towards the tunnel 20. On the contrary, there the connecting passage 70 has in cross section a simple angled path, so that in cross section a simple angled slit 86 is configured, which is open to the gas compartment 66 vertically downwards and to the treatment tunnel 20 laterally. The securing device 50 and the coupling device 56 of the trolley 34 are now matched to one another such that the securing device 50 can, as it were, encompass this angled connecting slot 86. To this end, the support profile 52 of the securing device 50 is configured to be correspondingly asymmetrical to the longitudinal median plane, as shown in FIG. 2.

In the exemplary embodiment shown in FIG. 3, the first connecting passage 70 between the treatment tunnel 20 and the gas compartment 66 has a double-angled course, so that in cross section a double-angled slit 88 is configured, open vertically downwards towards the gas compartment 66 and in contrast laterally displaced vertically upwards towards the treatment tunnel 20. There the struts 58 have a C-shaped section 90, following the course of the double-angled slit 88. At the articulated struts 60, this C-shaped section 90 is located above the articulation thereof.

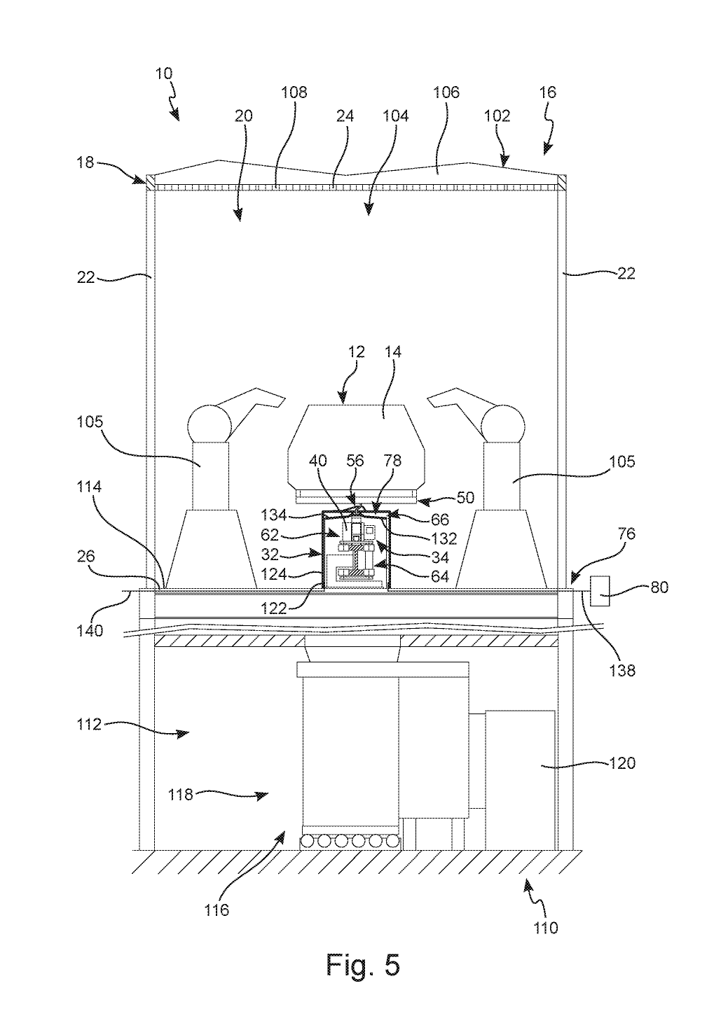

In the longitudinal section of the treatment device 16 shown in FIG. 4, the treatment tunnel 20 is coated from left to right and has in this conveying direction an inlet lock zone 92, a heating zone 94 and a holding zone 96, in each of which different temperatures prevail.

In the exemplary embodiment shown in FIG. 4, the gas compartment 66 is subdivided according to these zones 92, 94, 96 and according to any further zones arising in the conveying direction, by corresponding transverse bulkheads 98, into associated gas compartment sections, into each of which respective supply openings 100 of the gas supply device 76 empty, through which each gas compartment section can be supplied with gas. Not all supply openings 100 shown have been given a reference sign. Here, the gas supply device 76 can be arranged in such a way that individual or all sections of the gas compartment 66, irrespective of the other sections, can be supplied with gas with a varying volume flow and different conditioning, so that the gas flow can be matched to the respective tunnel atmosphere in a zone 92, 94, 96 in the treatment tunnel 20.

If necessary, for some or all sections of the gas compartment 66 separate conditioning devices 80 can be provided.

The separate sections allow, in the absence of trolleys 34, the gas supply to these sections to be reduced or interrupted.

The transverse bulkheads 98 in the gas compartment 66 are configured in such a way that the coupling device 56 can pass the transversal bulkheads 98. To this end, for the transverse bulkheads 98 by way of example flexible slats can be used. But motorised bulkheads can also be considered.

At the inlet and outlet on the ends of the treatment device 16, the gas compartment 66 has corresponding inlet or outlet bulkheads, not shown here. If necessary, a gas curtain can also be generated there with a volume flow that allows pressure development in the gas compartment 66 through the gas supplied.

The gas compartment 66 fluidically separates the treatment tunnel 20 and the driving area from one another such that only very small amounts of contamination can occur through mutual overflow of the components of the respective atmosphere prevailing in the treatment tunnel 20 or driving area 64. In this way, on the one hand corrosion of the conveyor system in the driving area 64 by aggressive atmospheric components is reduced and on the other pollution of the tunnel atmosphere in the treatment tunnel 20 is substantially prevented.

The conveyor system 32 is described as a floor conveyor system. In modifications not specifically shown conveyor systems with a different design can also be provided. In an in itself known overhead conveyor system the tunnel wall with the first connecting passage 70 is then correspondingly the tunnel ceiling 24. In other concepts, the guidance zone 62 can also be located laterally next to a side wall 22 of the treatment tunnel 20, which then correspondingly comprises the first connecting passage 70.

In modifications which are likewise not specifically shown, on the connecting passages 70 and/or 72 in their longitudinal direction additional screening means are provided. These can in particular be attached if it is intended to reduce or interrupt the gas supply at least to different sections of the gas compartment 66, as described above. In such cases also, escape of tunnel atmosphere from the treatment tunnel 20 should be as low as possible.

To this end, additional screening means can be provided, as described in the abovementioned DE 10 2015 006 098 A1 for a screening along the longitudinal extension of the connecting passage there in the tunnel floor. Thus, such screening means can, by way of example, be configured with a plurality of sealing slats, which are then pushed away by the struts 58 or articulated struts 60 of the trolley 34, when this moved in the treatment device 16. As an alternative to slats, brush-like elements can also be provided which cover the connecting passage(s) 70, 72. If necessary, in one or in several sections of the connecting passages 70, 72 in the longitudinal direction also of the connecting passages 70, 72 somewhat longer laterally moveable plates can be supported, which similarly are pushed away by the struts 58 or the articulated struts 60 of the connecting passage 70 or 72, when a trolley 34 passes through the treatment device 16. If the gas compartment 66 is supplied with gas in the presence of a trolley 34, it is harmless if large sections of the connecting passages 70, 72 are fluidically open. Such displaceable plates can in cross section, by way of example in relation to the respective connecting passage be curved like an inverted U, so that particles that may occur in the treatment chamber 20 or in the driving area 645 and flow in the direction of the gas compartment 66, are diverted to the side.

FIG. 5 now shows a treatment device 16 in the form of a coating device 102, in which the treatment tunnel 20 defines a coating tunnel 104. In the coating tunnel 104 application devices in the form of multi-axis application robots 105 are arranged, as known in and of themselves. By means of the application robots 105 the vehicle bodies 14, or other workpieces 12 to be coated, can be coated with the corresponding material. In particular, the workpieces 12 are painted in the coating device 102. During the application of coating material to the workpieces 14 overspray occurs in the treatment tunnel 20.

The ceiling 24 of the coating tunnel 104 in the coating installation 102 is flow-permeable and separates the coating tunnel 104 physically, that is to say therefore not fluidically, from an air supply chamber 106 arranged above it, which in technical circles is referred to as an air plenum.

The ceiling 24 as such is in the present exemplary embodiment configured as a filter cover 108, as known in and of itself.

The air supply chamber 106 can be supplied with conditioned air with the help of an air system 110, which flows downwards through the ceiling 24 as cabin air and further through the coating tunnel 104. The overspray in the coating tunnel 104 is absorbed and entrained by the cabin air.

The coating tunnel 104 is open downwards towards a system section 112 arranged below it in such a way that the tunnel floor 26 is similarly flow-permeable. To this end, the tunnel floor 26 is at least in sections configured as a passable grid 114.

In the bottom system section 112 overspray particles carried along by the cabin air are separated from the cabin air. To this end, the cabin air charged with the overspray is passed to a separation device 116 designated in its entirety by 116, located in a separation zone 118 of the bottom system section 112. A separation device 116 can, by way of example, comprise exchangeable filter units, be designed as an electronically operating separation device or also combine both these filter methods; both variants are known in and of themselves. Other filter concepts can also be implemented and combined.

In the separation device 116, overspray is separated. The cabin air now extensively free of overspray particles flows into a collection flow channel 120 and from there can be passed for further processing and conditioning and thereafter, in a circuit not shown specifically here, passed on as conditioned air of the air system 110 to the air supply chamber 106, from where it again flows from above into the coating tunnel 104.

In the coating installation 102, the guidance zone 62 with the driving area 64 is also arranged outside the treatment tunnel 20. However, unlike the dryer 28 the guidance zone 62 is above the tunnel floor 26 and is surrounded by a wall 122 and delimited by this from the treatment tunnel 20. Consequently, the wall 122 at the same time defines a further tunnel wall 124 of the treatment tunnel 20. This tunnel wall 124 separates the treatment tunnel 20 and the guidance zone 62, as happens with the dryer 28 by the tunnel wall in the form of the tunnel floor 26.

Along the tunnel floor 26, the guidance zone 62 can be delimited by a separate closed floor.

In another technical approach, the wall 122 can also be understood to be a section of the tunnel floor 26, which generally delimits the treatment tunnel 20 and here the coating tunnel 104 in sections. In this case, the tunnel floor 26 is a combination of grid areas and the wall 122.

In an overhead conveyor concept or a lateral arrangement of the guidance zone 62, the wall 122 and thus the tunnel wall 124 would be arranged below the ceiling 24 or inwards next to a side wall 22 and could correspondingly be understood to be a section of the ceiling 24 or the side wall 22 to be considered.

Both with the dryer 28 and the coating installation 102, the guidance zone 62 with the driving area 64 and the gas compartment 66 are configured below at least one section of a tunnel wall 26; 124 of the treatment tunnel 20.

With the dryer 28, the guidance zone 62 is located fully below the tunnel floor 26 there and with the coating installation 104, the guidance zone 62 is completely above the tunnel floor 26 in the form of the grid 114, wherein the tunnel floor 26 in this approach is understood to be a horizontal plane. In modifications not specifically shown, the guidance zone 62 can also be arranged such that a section extends above and a section below the tunnel floor 26.

With an overhead conveyor concept or a lateral arrangement of the guidance zone 62, the guidance zone 62 would correspondingly extend partly above and partly below the ceiling 24 or partly to either side of a side wall 22. The exemplary embodiments described above in the example of the dryer 28 of a treatment device 16 can be correspondingly implemented in a coating installation 104.

The exemplary embodiments now described below in the example of the treatment device 104 can also be correspondingly implemented in a dryer 28.

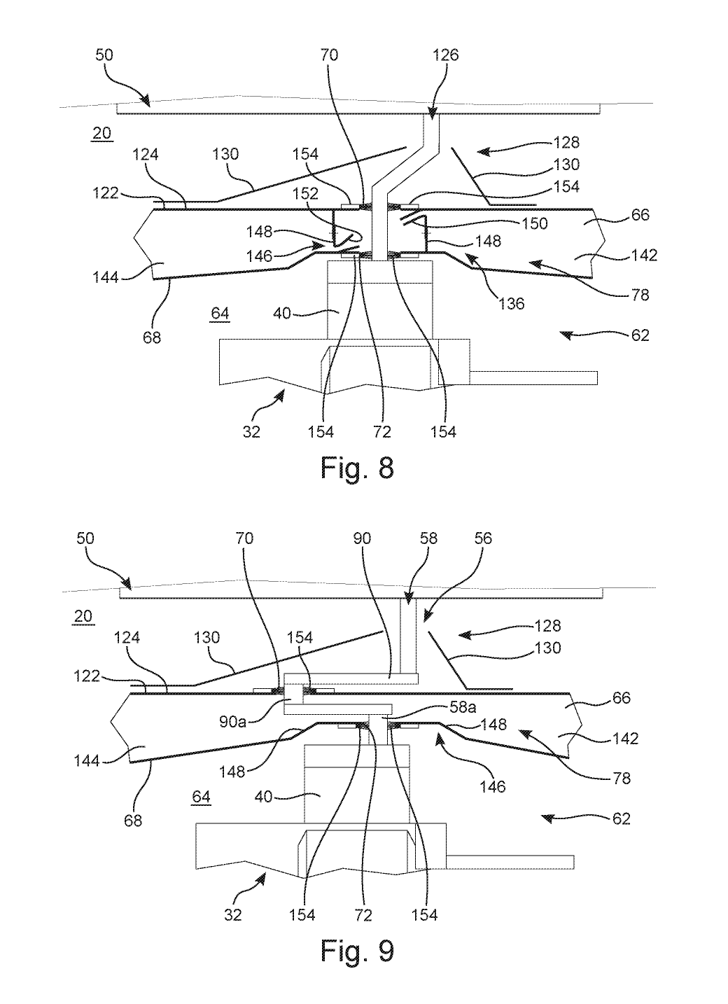

FIG. 6 now shows for the coating installation 102 the gas compartment 66 in a larger scale, arranged between the driving area 64 and the treatment tunnel 20, i.e. here the coating tunnel 104, and connected via the first connecting passage 70 in the gas compartment housing 68 with the treatment tunnel 20 and via the second connecting passage 72 with the driving area 64. The first and the second connecting passages 70, 72 are again complementary to the coupling device 56 of the trolleys 34.

Here also, the coupling device 56 extends through both connecting passages 70, 72 and the gas compartment 66, so that the securing device 50 with the workpiece 12 is located in the treatment tunnel 20 and the chassis 40 of a trolley 34 in the driving area 64.

In FIGS. 6 to 8 and 10 and 11, the coupling device 56 is configured as an angled strut 126 with a bottom vertical section 126a, which in the upwards direction merges into a section 126b inclined to a vertical plane, which for its part opens into a top, again vertical section 126c, coupled to the securing device 50. The sections 126a, 126b and 126c are only provided with reference signs in FIG. 6. The top vertical section 126c is correspondingly, seen in the longitudinal direction of the connecting passages 70, 72, in relation to the bottom vertical section 126a of the angled strut 126, laterally displaced.

In the present exemplary embodiments, the bottom vertical section 126a extends through both connecting passages 70, 72 and the gas compartment 66.

In the coating tunnel 104, a spray guard 128 is provided, which screens the first connecting passage 70 from the tunnel atmosphere charged with overspray. In the present exemplary embodiment, the spray guard 128 comprises two screening plates 130, extending in the longitudinal direction parallel to the first connecting passage 70 and flanking the movement path of the connecting strut 126 on both sides.

The gas compartment 66 is configured as a flow compartment, for which reason the gas compartment housing 68 comprises one or more gas inlets 132 and one or more gas outlets 134, which can only be identified FIGS. 5 and 6, wherein the gas barrier 78 flows from the one or more gas inlets 132 to the one or more gas outlets 134. The gas supply device 76 is arranged in such a way that the gas compartment 66 is supplied by one or more gas inlets 132 with gas for the gas barrier 78, which then flows through the gas compartment 66 along a flow path 136 and in doing so in the gas compartment 66 at least in part and at least in certain areas flows past the first connecting passage 70 and/or the second connecting passage 72 and thereafter is discharged through one or more gas outlets 134 from the gas compartment 66. The gas barrier 78 preferably flows over the full longitudinal extension of the connecting passages 70 and/or 72 and past these. If necessary, part of the gas of the gas barrier 78 can flow through the first and/or the second connecting passage 70, 72 and out of the gas compartment 66; this point is discussed again further on.

To this end, the gas supply device 76 comprises one or more gas supply lines 138, connected fluidically with the one or more gas inlets 132, via which the gas then enters the gas compartment 66. In addition, the gas supply device 76 comprises one or more gas discharge lines 140, connected fluidically with the one or more gas outlets 134, via which the gas flows out from the gas compartment 66.

A gas supply line 138 and a gas discharge line 140 are identified in FIG. 5 only.

So here the gas barrier 78 also always flows with a directional component perpendicularly to the conveying direction of the workpieces 12 or with a directional component perpendicularly to the longitudinal extension of the first connecting passage 70 or the second connecting passage 72. The main flow direction of the gas barrier 78 between a gas inlet 132 and a gas outlet 134 can be at an angle of 90° to the conveying direction of the workpieces 12 or to the longitudinal extension of the first connecting passage 70 or the second connecting passage 72, if a gas inlet 132 a gas outlet 134 are correspondingly coaxially opposite one another. If, on the other hand, a gas inlet 132 and a gas outlet 134 in the conveying direction of the workpieces 12 are arranged offset to one another, this angle can correspondingly also have values of greater than 0° and smaller than 90°.

The flow compartment 136 can comprise just one gas inlet 132 and just one gas outlet 134. However, in practice, the flow compartment 136 in the conveying direction of the workpieces 12, comprises a plurality of gas inlets 132 and gas outlets 134, so that the most uniform possible flow of the gas barrier 78 along the entire length of the gas compartment 66 and the connecting passages can be achieved.

FIGS. 5 to 10 show exemplary embodiments, in which the gas compartment 66 defines an entrance zone 142 with the one or more gas inlets 132 and an exit zone 144 with the one or more gas outlets 134 and in which the entrance zone 142 and the exit zone 144 in the conveying direction of the workpieces 12 are opposite one another. FIG. 11 shows a variant, in which the one entrance zone 142 and an exit zone 144 in the conveying direction of the workpieces 12 are arranged on the same side; this point is dealt with in more detail later.

In the exemplary embodiments in FIGS. 6 to 10 the gas compartment 66 comprises a flow guiding device 146 with flow guiding elements 148, by which the flow section for the gas barrier 78 between the entrance zone 142 and the exit zone 144 is reduced, before the gas of the gas barrier 78 flows past the first connecting passage 70 and/or the second connecting passage 72.

To this end, the flow guiding device 146 in the exemplary embodiment according to FIG. 6 comprises two opposing, with respect to the conveying direction of the workpieces 12, flow guiding elements 148, so that in the flow direction before the first connecting passage 70 a first flow slot 150 at the entrance zone 142 and in the flow direction after the first connecting passage 70 an opposing second flow slot 152 in the exit zone 144, are configured, extending in the longitudinal direction of the first connecting passage 70. Here, the opposing flow slots 150, 152 are arranged at the same vertical height.

In a modification, the slots 150, 152 can each be covered by opposing perforated plates or similar, so that in the conveying direction of the workpieces 12 a plurality of opposing connecting passages is configured, which can be coaxial or offset to one another in the conveying direction of the workpieces 12. The connecting passages in such perforated plates can have varying cross sections and by way of example be configured as slots or circular passages or passages with oval cross section. In a further modification, the flow sections of the flow passages can be altered. By way of example, to this end an immovable perforated plate can work in concert with a displaceably mounted perforated plate, resting on the immovable perforated sheet.

On the second connecting passage 72 between the driving area 64 and the gas compartment 66 screening means are provided in the form of brush elements 154. The abovementioned screening means can also be provided as an alternative to brush elements.

In the area between the brush elements 154 and the flow slots 150, 152 gas of the gas barrier 78 can, if necessary, flow in, which then, under suitable pressure conditions, can flow into the driving area 64 downwards past the brush elements 154 through the second connecting passage 72 into the driving area 64.

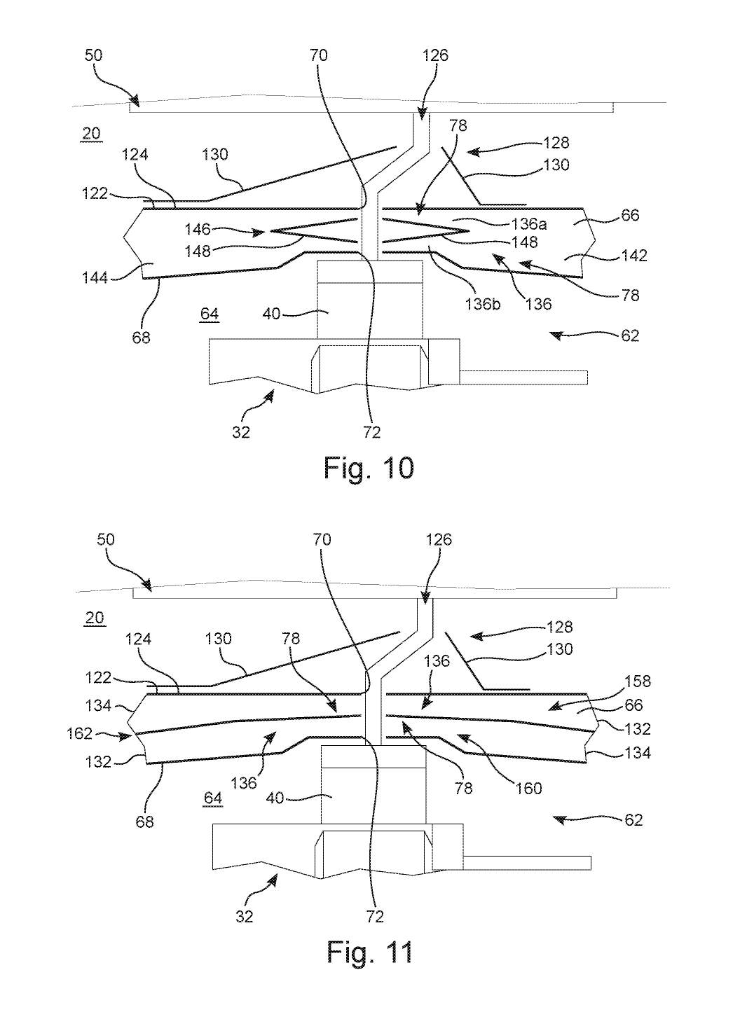

FIG. 7 shows a variant in which the flow guiding device 146 is part of the gas compartment housing 68 and defines the second connecting passage 72 between the driving area 64 and the gas compartment 66. There also, on the second connecting passage 72, brush elements 154 are provided as screening means. In this exemplary embodiment the area directly below the brush elements 154 identifiable in FIG. 7 consequently belongs to the driving area 64. The flow guiding device 146 is consequently arranged in such a way that the flow section for the gas barrier 78 between the entrance zone 142 and the exit zone 144 is reduced, before gas of the gas barrier 78 flows past both the first connecting passage 70 and the second connecting passage 72.

At the first connecting passage 70 also, between the gas compartment 66 and the coating tunnel 104, suitable screening means can be provided. These are shown by way of example in FIGS. 8 and 9.

In the exemplary embodiment according to FIG. 8, the opposing flow slots 150, 152 are also not arranged at the same vertical height, but at vertically different heights. Here, the first flow slot 150 at the entrance zone 142 is in a higher vertical position than the second flow slot 152 at the exit zone 144. The first flow slot 150 is also inclined downwards and the second flow slot 152 complimentarily upwards, so that the gas barrier 78 flows downwards between the flow slots 150, 152 with respect to a horizontal plane.

In a modification, not specifically shown, the conditions can also be reversed, so that the gas barrier 78 flows diagonally from bottom to top.

In addition, the flow slot 152 of the exit zone 144 has a larger flow cross section than the flow slot 150 of the entrance zone 142.

FIG. 9 shows an exemplary embodiment, in which the flow guiding device 146 is similarly part of the gas compartment housing 68. There, the narrowing of the flow section for the gas barrier 78 between the entrance zone 142 and the exit zone 144 is simply less than, by way of example, in the exemplary embodiment according to FIG. 7.

Furthermore, FIG. 9 shows a variant in which the coupling device 56, which couples the chassis 40 of the trolley 34 to the securing device 50, is equipped with struts 58, comprising a C-shaped section 90, as has already been described for the exemplary embodiment according to FIG. 3. In the exemplary embodiment shown here, this coupling device 56 and the dimensions and arrangements of the gas compartment housing 68 and the connecting passages 70, 72 are matched to one another such that a vertical section 58a of the strut 58, which joins the chassis 40 with the C-shaped section 90, extends through the second connecting passage 72 between driving area 64 and gas compartment 66. A vertical section designated by 90a in FIG. 9 of the C-shaped section 90 extends through the first connecting passage 70. The connecting passages 70 and 72 accordingly run, with respect to the conveying direction of the workpieces 12, with a lateral offset to one another.

With the dryer 28 also, this configuration can be an advantage since the gas barrier 78, compared to the other exemplary embodiments, has a relatively long flow along the coupling device 56 and heat is discharged from the coupling device.

In the exemplary embodiment according to FIG. 10, the flow path 136 of the gas barrier is divided by the flow guiding elements 148 in the gas compartment 66 into a first flow path segment 136a and a second flow path segment 136b, wherein the first flow path segment 136a passes by the first connecting passage 70 and the second flow path 136b passes by the second connecting passage 72.

In the exemplary embodiment shown in FIG. 11, the flow guiding device 146 is arranged so that the gas barrier 78 flows past the first connecting passage 70 and the second connecting passage 72 with opposing flow directions. The gas compartment 66 is arranged in such a way that the gas barrier 78 can flow through it according to the counter current principle.

For this purpose, the gas compartment 66 is divided by means of partitions 156 into a first flow zone 158 facing the first connecting passage 70 and a second flow zone 160 facing the second connecting passage 72.

In a first variant each of the flow zones 158, 160 is associated on opposing sides with one or more gas inlets 132 and one or more gas outlets 134 in such a way that the flow zones 158, 160 can be supplied independently of the gas supply device 76 with gas for the gas barrier 78.

In a second variant, both flow zones 158, 160 are connected together by a diverter 162, in particular by one or more diverter channels. In this way, the gas for the gas barrier 78 flows by way of example into the first flow zone 158, and through this in a first flow direction, is diverted by the diverter 162 into the second flow zone 160, through which the gas then flows in the opposite direction, and leaves via available gas outlets 134.

In a further variant, not specifically shown, the flow zones 158, 160 on both sides can be connected by a respective diverter 162, so that the gas barrier 78 can flow in a circuit. Any gas losses occurring are compensated for by the gas supply device 76, by a corresponding volume being supplied to the gas compartment 66.

In all exemplary embodiments of the coating installation 102 with the gas compartment 66 flowing from the entrance zone 142 to the exit zone 144, as a result of the Venturi effect tunnel atmosphere charged with overspray may be sucked from the coating tunnel 104 through the first connecting passage 70 into the gas compartment 66. In this way, the gas of the gas barrier 78 becomes contaminated with tunnel atmosphere and in particular with overspray.

If this is the case, the one or more gas discharge lines 140 can for example lead into the separation zone 118 of the coating installation 101, where the gas charged with overspray can be mixed with the cabin air and then arrive at the separation device 116.

Apart from the flow guiding elements 148 described above, in addition or alternatively, flaps, valves and/or fans can be provided, with the help of which the volume flow of the gas barrier 78 and/or the pressure of the gas barrier 78 in the gas compartment 66 can be adjusted.

The flow conditions of the gas barrier 78 in the gas compartment 66, the tunnel atmosphere in the treatment tunnel 20 and the atmosphere in the driving area 64 can be matched to one another in various ways, so that different effects can be achieved. On the one hand the gas barrier 78 can be designed in such a way that at neither of the connecting passages 70 or 72 any escape of gas of the gas barrier 78 into the treatment tunnel 20 or the driving area 64 and no entry of tunnel atmosphere from the treatment tunnel 20 or atmosphere from the driving area 64 into the gas compartment 66 occurs. Alternatively, it can be ensured that part of the gas of the gas barrier 78 can escape into the treatment tunnel 20 and/or into the driving area 64. The flow conditions can also be set so that the tunnel atmosphere from the treatment tunnel 20 and/or atmosphere from the driving area 64 can enter the gas compartment 66.

Mixed variants are also possible. By way of example, gas of the gas barrier 78 can flow through the first connecting passage 70 into the treatment tunnel 20 and atmosphere from the driving area 64 through the second connecting passage 72 can enter the gas compartment 66.

Flow losses, in particular at the start and end of the treatment tunnel can if necessary be stopped by suitable locks or by an adaptation of the pressures and or by the volume flows made available. Varying adaptation of the pressure and/or of the volume flow of the gas for the gas barrier 78 can, if necessary, take place locally and does not have to be uniform over the length of the gas compartment 66 in the conveying direction of the workpieces 12. Thus, different pressure and volume flow conditions may be necessary for different zones in the treatment tunnel 20. The required conditions must be aligned with system parameters including the temperatures, prevailing pressures and humidity, prevailing in the adjacent spaces, i.e. in a zone of the driving area 64, a zone adjacent to this zone of the gas compartment 66 and a zone of the treatment tunnel 20 in turn adjacent to this zone.

With a dryer 28, in practice the alternatives will be selected in which the gas barrier 78 can flow extensively without atmosphere exchange past the connecting passages 70, 72 or at least through the first connecting passage 70 into the drying tunnel 30 and, if necessary, also through the second connecting passage 72 into the driving area 64. This ensures that the polluting tunnel atmosphere of the drying tunnel 30 cannot enter the driving area.

With the coating installation 102 in practice it is the variant described above that is actually preferred, in which at least when passing via the first connecting passage 70 an overflow of the tunnel atmosphere from the coating tunnel 104 into the gas compartment 66 is possible. Thus, any undesired impurities, entrained with the gas for the gas barrier 78, are kept away from the coating tunnel 104.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

What is claimed is:

1. A treatment installation for treating workpieces comprising:
a) a treatment device with a housing, in which a treatment tunnel is accommodated;
b) a conveyor system comprising a plurality of trolleys by means of which workpieces are transportable through the treatment tunnel, wherein each trolley comprises a chassis and a securing device for at least one workpiece, which are coupled together by means of a coupling device;
wherein
c) outside the treatment tunnel a guidance zone with a driving area for the chassis is present,
further wherein
d) in the guidance zone a gas compartment is configured, arranged between driving area and the treatment tunnel and delimited by a separate housing; and
e) a gas-supply device is present, by means of which the gas compartment can be supplied with a gas such that in the gas compartment a gas barrier is created between the treatment tunnel and the driving area.

2. The treatment installation according to claim 1, wherein the gas compartment is connected via a first connecting passage with the treatment tunnel and via a second connecting passage with the driving area, such that the chassis of a trolley in the driving area is movable and in the process the securing device is also taken into the treatment tunnel and the coupling device extends through the first and the second connecting passage and the gas compartment.

3. The treatment installation according to claim 2, wherein the first connecting passage and/or the second connecting passage is or are straight or angled.

4. The treatment installation according to claim 2, wherein by means of the gas supply device a pressure can be developed in the gas compartment, which is greater than the pressure in the treatment tunnel and/or than the pressure in the driving area.

5. The treatment installation according to claim 1, wherein the gas compartment is configured as a flow compartment, wherein the gas compartment housing to this end comprises one or more gas inlets and one or more gas outlets.

6. The treatment installation according to claim 5, wherein the gas supply device is arranged such that the gas compartment is supplied through one or more gas inlets with gas for the gas barrier, which flows through the gas compartment along a flow path and in doing so in the gas compartment at least in part and at least in certain areas flows past the first connecting passage and/or the second connecting passage and thereafter is discharged through one or more gas outlets from the gas compartment.

7. The treatment installation according to claim 6, wherein the gas barrier over the full longitudinal extension of the first connecting passage and/or the second connecting passage flows at least in part past these.

8. The treatment installation according to claim 1, wherein the gas compartment comprises a flow guiding device, by means of which the flow section for the gas barrier is reduced, before gas of the gas barrier flows past the first connecting passage and/or the second connecting passage.

9. The treatment installation according to claim 8, wherein the flow guiding device comprises flow guiding elements.

10. The treatment installation according to claim 5, wherein the gas compartment is arranged such that the gas barrier is able to flow through it according to the counter current principle, so that gas of the gas barrier flows past the first connecting passage and past the second connecting passage in opposing flow directions.

11. The treatment installation according to claim 1, wherein the gas supply device comprises a conditioning device, by means of which the gas to be supplied to the gas compartment can be conditioned.

12. The treatment installation according to claim 1, wherein the guidance zone with the driving area and the gas compartment is configured below at least a section of a tunnel wall of the treatment tunnel.

13. The treatment installation according to claim 1, wherein the coupling device comprises at least one vertical strut, in particular an articulated strut.

14. A method for treating workpieces comprising:
passing workpieces through a treatment tunnel by means of a conveyor system, the conveyor system comprising a plurality of trolleys by means of which the workpieces are conveyed through the treatment tunnel, wherein each trolley comprises a chassis and a securing device for at least one workpiece which are coupled together by means of a coupling device, and wherein outside the treatment tunnel a guidance zone with a driving area for the chassis is present
and further wherein
a gas compartment, arranged in the guidance zone between the driving area and the treatment tunnel and delimited by a separate housing, is supplied with a gas such that in the gas compartment a gas barrier is created between the treatment tunnel and the driving area.

15. The method according to claim 14, wherein the gas compartment is connected via a first connecting passage with the treatment tunnel and via a second connecting passage with the driving area, wherein the chassis of a trolley in the driving area is movable and in the process the securing device is also taken into the treatment tunnel and the coupling device extends through the first and the second connecting passage and the gas compartment.

16. The method according to claim 14, wherein in the gas compartment a pressure is developed, that is higher than the pressure in the treatment tunnel and/or the pressure in the driving area.

17. The method according to claim 14, wherein the gas compartment is configured as a flow compartment, wherein the gas compartment housing to this end comprises one or more gas inlets and one or more gas outlets.

18. The method according to claim 17, wherein the gas compartment is supplied by one or more gas inlets with gas for the gas barrier, which flows through the gas compartment along a flow path and in doing so in the gas compartment at least in part and at least in certain areas flows past the first connecting passage and/or the second connecting passage and thereafter is discharged through one or more gas outlets from the gas compartment.

19. The method according to claim 18, wherein over a full longitudinal extension of the first connecting passage and/or the second connecting passage the gas barrier flows flows at least in part past these.

20. The method according to claim 14, wherein the flow section for the gas barrier is reduced, before gas of the gas barrier flows past the first connecting passage and/or the second connecting passage, by means of a flow guiding device.

21. The method according to claim 20, wherein the flow guiding device comprises flow guiding elements.

22. The method according to claim 14, wherein the gas barrier is able to flow through the gas compartment according to the counter current principle, so that gas of the gas barrier flows past the first connecting passage and past the second connecting passage in opposing flow directions.

23. The method according to claim 14, wherein the gas to be supplied to the gas compartment is conditioned by means of a conditioning device.

24. The method according to claim 14, wherein the guidance zone with the driving area and the gas compartment is configured below at least a section of a tunnel wall of the treatment tunnel.
